(19) United States
(12) Patent Application Publication
(10) Pub. No.: US 2006/0095457 A1
(43) Pub. Date: May 4, 2006

(54) Interactive tool for knowledge-based support of planning under uncertainty

(76) Inventors: David William Glasspool, London (GB); John Paul Fox, London (GB)

Correspondence Address: TIMOTHY A. FRENCH;Fish & Richardson P.C., 225 Franklin Street, Boston, MA, 02110-2804, US

(21) Appl. No.: 09/760,392

(22) Filed: Jan. 12, 2001

(51) Int. Cl. G06F 7/00

(52) U.S. Cl. 707/102

(57) ABSTRACT

A planning tool provides support in planning, decision making and process management under conditions of uncertainty by combining a plan generating tool for manipulating and displaying a visual representation of a plurality of schedule elements along a time line with a domain-specific knowledge database that enables determination of quantitative and qualitative outcome measures resulting from a currently defined plan. The quantitative and qualitative outcome measures are computed and displayed in real time as the plan is being manipulated by the user so that instantaneous feedback of the consequences of a particular plan can be visualised by the user during generation of the plan.

The present invention relates to computer systems that provide support and assistance in process management event scheduling, and in particular to such systems applied to planning and decision making processes.

There is a wide range of software tools available that can assist in complex project management task or event scheduling. Such project management software tools typically facilitate the graphic presentation of tasks and events of a process flow, along a time line, in a Gantt chart type representation or plan.

More sophisticated project management software tools include planning tools that take into account conflicts and constraints between different tasks and events. These ensure sequentiality or concurrency of tasks that have specific interdependencies, for example where a second task requires the output of a first task in order to be completed, or where first and second tasks must be carried out concurrently for efficient use of available resources. These planning tools assist the user in determining a critical path for a particular project. Other facilities may include the ability of the software tool to generate a graph of cost over time for the tasks scheduled in the project.

An overview of such prior art project management tools is found in “Going to Plan”: What Micro? December 1991, pp. 102-108.

The prior art planning tools require the user to have a reasonably high level of expertise, both in the project planning mechanism and also in the specific technological art (hereinafter referred to as the “domain”) in which the tasks are being planned, in order to understand and allow for the consequences of particular combinations or permutations of planned tasks, actions and events. The prior art planning tools do not have the facility to interface with a specialised knowledge-base that can be automatically interrogated by the planning software to automatically assess a particular plan in such a way as to provide the user with feedback on the plan viability indicating risk factors, likelihood of success or optimal outcome and other “outcome measures”, including arguments for and against a particular plan.

In particular, the prior art planning tools do not provide feedback concerning the effectiveness of a proposed plan, nor do they provide analysis of plans based on expert knowledge (encoded for example in a set of rules) of the situation or domain in which the plan is being constructed. For example, in the case of commercial project planning tools such as “Microsoft Project” this expert knowledge would correspond to detailed information specific to the particular situation in which the project is to be carried out, such as peculiarities of the industry sector or type of workforce, equipment or plant involved; in computing terms, they do not provide “knowledge-based” analysis of plans.

A number of software tools and algorithms exist which provide analysis of risks, costs or benefits based on information provided about a situation. For example medical risk algorithms exist which determine the risk of a patient developing a medical condition (such as coronary heart disease) based on the current physical state, age and lifestyle of a patient (eg. “A simple computer program for guiding management of cardiovascular risk factors and prescribing”, A D Hingorani & P Vallance, 1999, British Medical Journal 318, pp. 101-105; and “Cardiovascular disease profiles”, K Anderson, et al, 1991, American Heart Journal 121, pp. 293-298).

Considerable work has been carried out developing knowledge-based decision support systems. Such systems apply a body of knowledge, typically encoded in the form of a set of rules, to a particular decision and provide advice to the decision maker on the basis of such knowledge. The utility of such systems in planning tasks is limited, however, in that they typically provide support for a single decision rather than for a set of interrelated decisions as may be required in generating a plan.

Research in the field of human-computer interaction has shown that the provision of appropriate dynamic feedback in computer interfaces can dramatically improve accuracy and speed in carrying out complex tasks (see, for example, “External cognition: how do graphical representations work?”, M Scaife and Y Rogers, 1996, International Journal of Human-Computer Studies 45, pp. 185-215). In particular, making the constraints between variables in complex tasks obvious by appropriate design of graphical interfaces facilitates those tasks (see, for example) “Representations in distributed cognitive tasks”, J Zhang and D A Norman, 1994, Cognitive Science 18, pp. 87-122).

It is an object of the present invention to provide a planning tool that combines a plan construction tool with a specialised knowledge database for automatic assessment of likely outcome measures that are consequential on the plan constructed.

It is another object of the present invention to provide a planning tool for the construction and modification of plans of action in situations where uncertainty or risk are associated with the outcome of actions or plans and where complex relationships or constraints may exist between the elements of a plan, that enables the user to visualise the uncertainties or risks of a currently defined plan during and after the plan constriction.

It is a further object of the present invention to provide a planning tool which provides immediate visual feedback of preselected outcome measures as a consequence of manipulating planned actions and events.

According to one aspect, the present invention provides a planning apparatus comprising:

means for displaying a visual representation of a plurality of schedule elements along a time line;

means for enabling manipulation, by a user, of relative positions and extents of the plurality of schedule elements along the time line to form a plan;

a database of relationship data including interdependencies and planning constraints between specified ones of the schedule elements;

a domain-specific knowledge database of outcome measures providing quantitative or qualitative measures of outcomes consequent on specific schedule elements or specific combinations, sequential or otherwise, of schedule elements on the plan according to a predetermined domain of use of the planning apparatus;

means for displaying, during or after manipulation of events by the user, selected outcome measures resulting from the specific sequence of schedule elements currently displayed.

According to another aspect, the present invention provides a planning apparatus comprising:

means for displaying a visual representation of a plurality of schedule elements along a time line;

means for enabling manipulation, by a user, of relative positions and extents of the schedule elements along the time line to form a plan;

an instance database storing data defining the schedule elements of the current plan and session data specific to that plan;

means for enabling selection, by a user, of a domain in which the plan is effected, the selected domain determining the schedule elements available to form the plan;

means for accessing a domain-specific knowledge database of predetermined outcome measures so as to provide quantitative or qualitative measures of outcomes consequent on the schedule elements selected in the current plan and the positioning thereof;

means for displaying, during or after manipulation of events by the user, selected outcome measures resulting from the current configuration of schedule elements in the plan.

According to another aspect, the present invention provides a method for automatically determining a level of desirability of a plan comprising a plurality of schedule elements along a time line, the method comprising the steps of:

displaying, on a computer apparatus, a visual representation of said plurality of schedule elements along the time line;

enabling manipulation, by a user, of relative positions and extents of the schedule elements along the time line to form said plan;

accessing a database of relationship data including interdependencies and planning constraints between specified ones of the schedule elements to automatically indicate, on the computer display, conflicts between plan elements;

accessing a domain-specific knowledge database of outcome measures providing quantitative or qualitative measures of outcomes consequent on specific schedule elements or specific combinations, sequential or otherwise, of schedule elements on the plan according to a predetermined domain of use of the planning apparatus to automatically determine selected outcome measures resulting from the current plan configuration being displayed; and

displaying, during or after manipulation of events by the user, said selected outcome measures.

According to another aspect, the present invention provides a method for automatically determining a level of desirability of a plan comprising a plurality of schedule elements along a time line, the method comprising the steps of:

displaying, on a computer apparatus, a visual representation of said plurality of schedule elements along the time line;

enabling manipulation, by a user, of relative positions and extents of the schedule elements along the time line to form a plan;

storing, in an instance database, data defining the schedule elements of the current plan and session data specific to that plan;

enabling selection, by a user, of a domain in which the plan is effected, the selected domain automatically determining the schedule elements available for use to form the plan;

accessing a domain-specific knowledge database of predetermined outcome measures so as to automatically provide quantitative or qualitative measures of outcomes consequent on the schedule elements selected in the current plan and the positioning thereof; and

displaying, during or after manipulation of events by the user, selected said outcome measures resulting from the current configuration of schedule elements in the plan.

Embodiments of the present invention will now be described by way of example and with reference to the accompanying drawings in which:

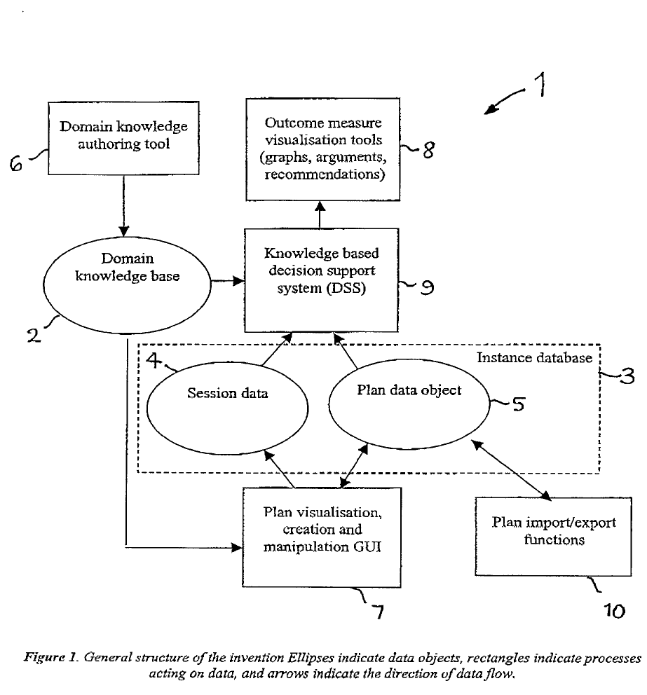

FIG. 1 is a schematic block diagram of the various components of an interactive planning tool according to one embodiment of the present invention;

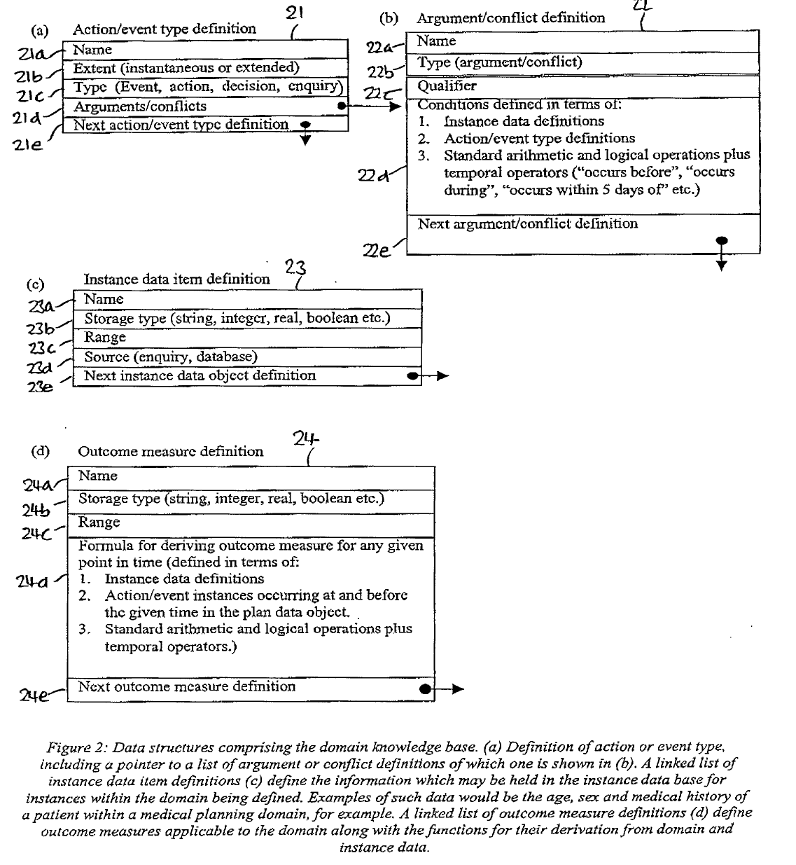

FIG. 2 is a schematic diagram of exemplary data structures used in a domain knowledge database of the planning tool of FIG. 1;

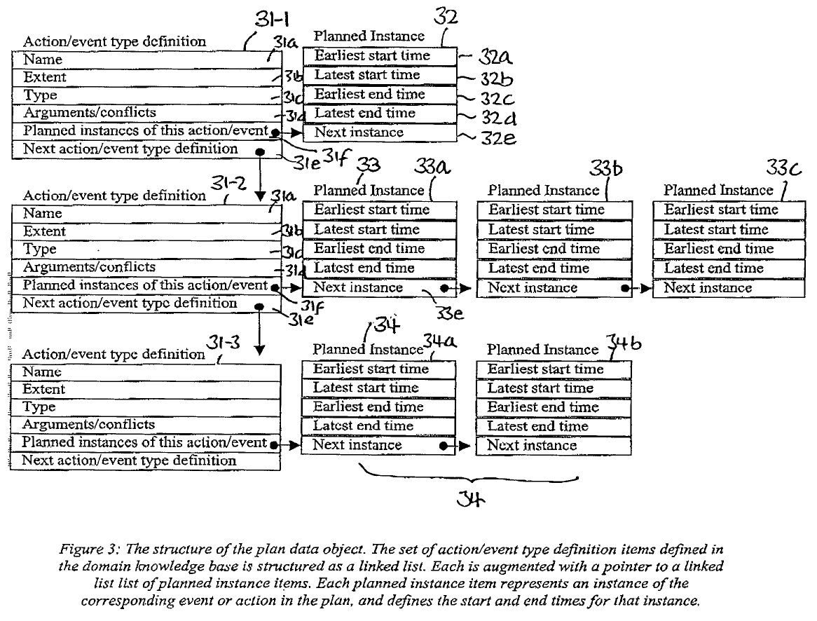

FIG. 3 is a schematic diagram of exemplary data structures used in a plan data object of the planning tool of FIG. 1;

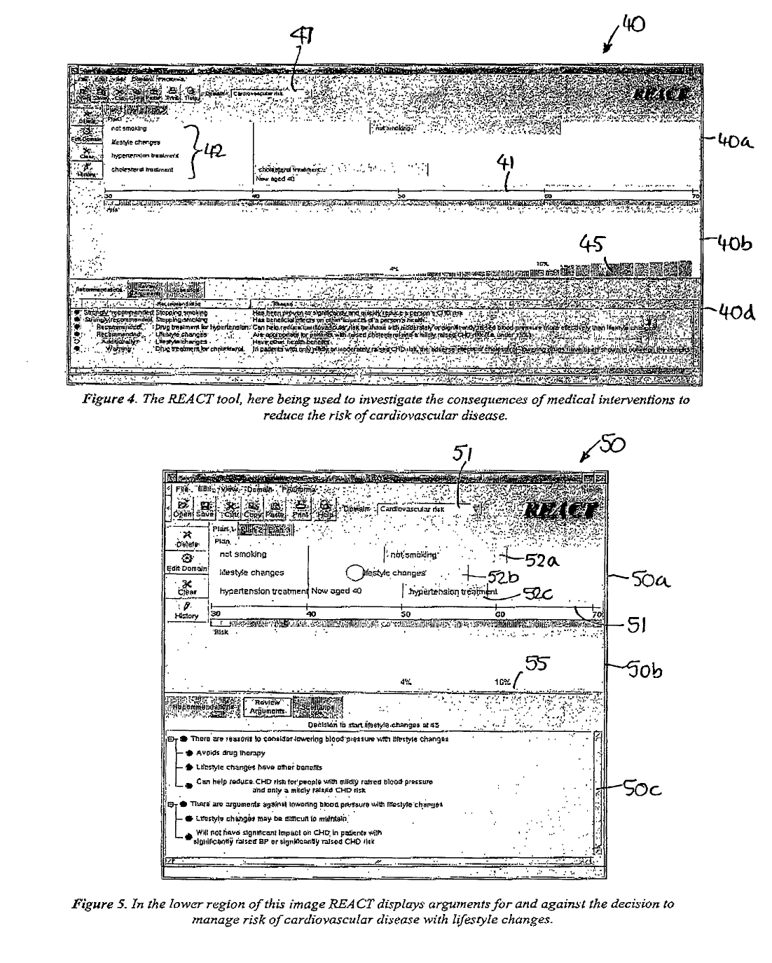

FIG. 4 is a exemplary output display of the interactive planning tool of FIG. 1, used in a clinical domain for investigating the consequences of medical interventions to reduce risk of cardiovascular disease;

FIG. 5 is an exemplary output display of the interactive planning tool of FIG. 1, used in a clinical domain, for showing arguments for and against a current plan;

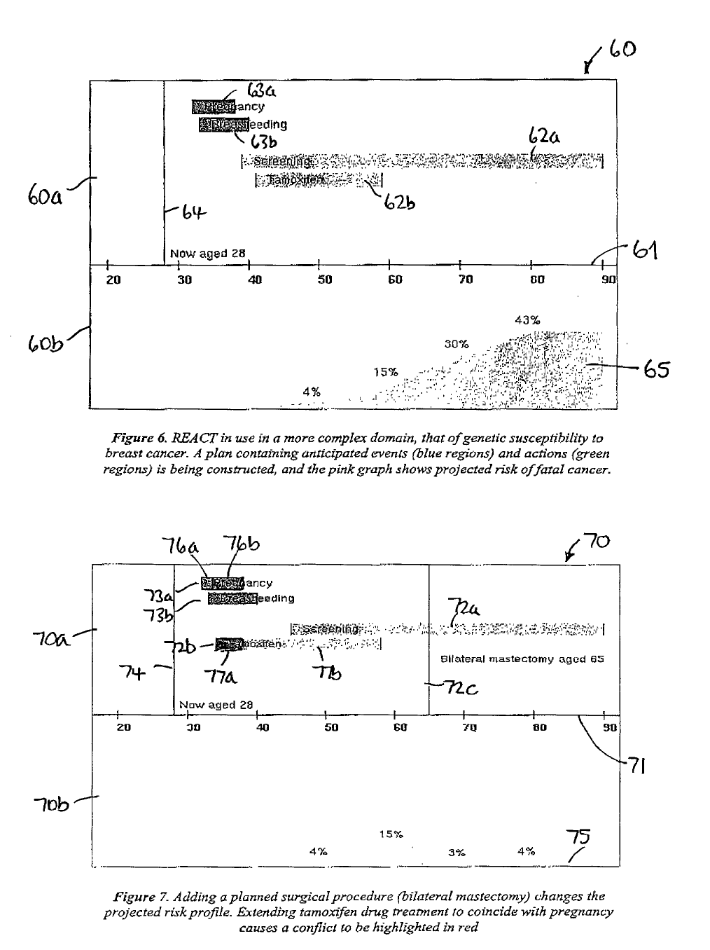

FIG. 6 is an exemplary output display of the interactive planning tool of FIG. 1, used in a clinical domain to indicate projected risk of breast cancer arising from a specified plan;

FIG. 7 is an exemplary output display similar to FIG. 6, but modified to indicate changes in risk arising from a varied plan; and

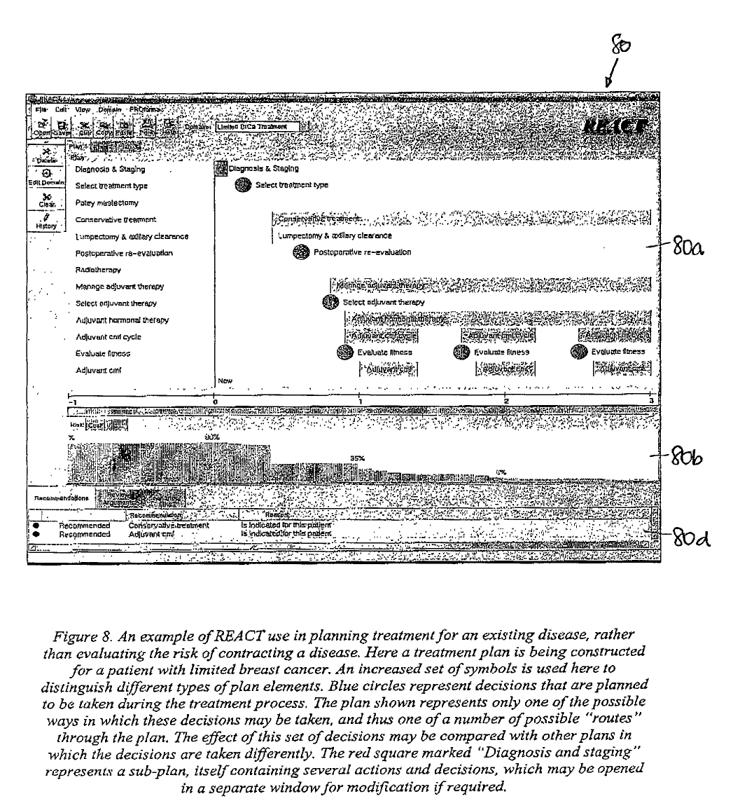

FIG. 8 is an exemplary output display of the interactive planning tool of FIG. 1, used in a clinical domain for the planning of a treatment schedule for an existing breast cancer condition.

The present invention provides a planning tool for assisting a user in the construction and modification of plans of action in situations where uncertainty or risk are associated with the outcome of actions or plans and where complex relationships or constraints may exist between the elements of a plan. The expression “elements” of a plan will be used hereinafter to refer to planned tasks, actions or other events that form part of the plan, and may include past events.

Plans of action must often be prepared in situations where the outcomes of actions are uncertain and that uncertainty must be allowed for or minimised, or where risk attaches to the outcomes of actions and that risk must be minimised. Examples include short, medium and long-term business planning, financial forecasting, industrial process design, and medical care planning. In the present description, specific examples in the medical care planning domain will be illustrated, but it will be understood that the invention readily extends into other “knowledge domains” or planning environments.

Planning in such situations often involves manipulating multiple possible plan elements which may have complex interdependencies or constraints. An example is the use of drugs or medical procedures in a medical care plan which may either rely on, or conflict with, the use of other drugs or procedures.

The planning tool described herein is adapted to support a user who must generate or modify a plan of action in such situations, without necessarily having detailed knowledge of, or even comprehending, the domain-specific implications or consequences of the use of various elements in the plan, their relative positioning or timing. Thus, in the clinical examples given, it is possible for the planning tool to be used by clinicians and other persons of varying levels of medical knowledge either to form the plans or to illustrate possible outcomes directly to patients having little or no medical knowledge.

In the preferred embodiment, the planning tool provides a graphical user interface for manipulating plan elements in such a way that immediate dynamic feedback is continually provided to the user of the consequences of changes to the plan.

With brief reference first to FIGS. 6 and 7, an exemplary output display 60, 70 provides a graphical user interface (GUI) window 60a, 70a. The output display 60, 70 includes a time line 61, 71 running from left to right and representing a course of time over which a plan is to extend. In the case of FIGS. 6 and 7, this time line corresponds to the age of a human subject or patient. Planned actions (62a, 62b; 72a-c) and anticipated events (63a, 63b; 73a, 73b) may be drawn by the user, in the GUI window 60a, 70a, using well known selection and “click-and-drag” type techniques or the like. The user can readily manipulate the existence, positioning and duration of elements 62, 63, 72, 73 referenced to the time line 61, 71, and may also include past events to the left of the vertical bar 64, 74 representing the current position on the time line. FIGS. 6 and 7 will be discussed in greater detail later.

The planning tool uses a knowledge database specific to the domain of the planned actions continually during creation and modification of the plan, to provide immediate and continuous feedback of possible outcomes of the plan, including levels of risk, cost, benefit or other outcome measures, and dependencies and constraints between plan elements 62, 63, 72, 73. In the illustration of FIGS. 6 and 7, the GUI windows 60a, 70a of the displays provide the graphical user interface for manipulating planned actions, and the lower windows 60b, 70b of the displays 60, 70 provide real time output of outcome measures resulting from the presently displayed plan. In the illustration, the outcome measure 65, 75 selected for display is a quantitative assessment of the likelihood of contracting breast cancer in the presence of a genetic susceptibility, based on the events and actions currently scheduled in the plan.

With reference to FIG. 1, a preferred embodiment of the planning tool 1 is now described. Preferably, the planning tool is implemented in software on a conventional computer system including conventional input and output apparatus such as keyboard, mouse or other pointing device, video monitor and printer. In FIG. 1, ellipses indicate data objects, rectangles indicate processes acting on data, and arrows indicate a direction of data flow.

Data in the planning tool is separated into two databases. A domain knowledge database 2 stores generic information relating to a particular domain or technological area in which the planning is taking place. With reference to the example of FIGS. 6 and 7, this domain would be a clinical domain, and more specifically, the domain of treatment and assessment of breast cancer in the human female. In this example, the knowledge database would contain statistical information from clinical population studies regarding the likelihood of developing fatal breast cancer.

A domain of application might alternatively be, for example, house purchasing, personal financial planning or medical care planning for a different disease, although many other technical fields are envisaged.

An instance database 3 stores data pertaining to a particular instance for which the tool is being used, within a domain. With reference to the example of FIGS. 6 and 7, this instance data would correspond to an individual human subject or patient, including the patient's age and medical history, and specific plan elements for that subject.

This instance data is stored as session data 4 and as a plan data object 5. Session data 4 is static throughout a particular session, and includes information such as the age and medical history of the subject. The plan data object 5 defines the plan currently under consideration (as displayed in the graphical user interface windows 60a, 70a) that can be modified during a planning session.

With reference to FIG. 2, exemplary data structures used in the domain knowledge database 2 are now described. The generic information in the domain knowledge database specifying such a domain preferably comprises four types of data structures each stored as a linked chain of records.

The first type of data structure in the domain knowledge database 2 includes a series of action/event type definition records 21. Each record 21 is used to store a type of action or event (“element”) that could be used in a plan. Each of these records will correspond to one type of element that may be used in a plan such as the actions 62, 72 and events 63, 73 illustrated in FIGS. 6 and 7.

Each record 21 comprises a plurality of fields including: an event name or identifier 21a; an extent flag 21b indicating whether the event is an instantaneous type or extended in time; a type flag 21c indicating whether the record pertains to an event, an action, a decision, or an enquiry; an argument/conflict pointer 21d which contains the address of an argument/conflict definition record; and a next record pointer 21c which points to the next action/event type record in the chain.

The argument/conflict pointer 21d points to a record in a second type of data structure in the domain knowledge database 2—a linked chain of records of argument, recommendation or conflict definitions 22.

Each record 22 in the argument/conflict definitions data structure includes a plurality of fields including: a name or identifier 22a; a type flag 22b indicating whether the record pertains to an argument or conflict definition; a qualifier flag 22c, a set of conditions 22d, and a next record pointer 22e which points to the next argument/conflict record in the chain.

The conditions 22d specify under which circumstances the argument or conflict specified becomes active. Values of data to be found in the instance database 3 session data 4 and specific combinations of instances of actions or events in the plan data object 5 may be included in the set of conditions 22d, and may be related using logical, arithmetic and temporal operators. Examples of typical conditions 22d are: “If action X occurs after event Y”; “if action X occurs when instance data item Y has value V”, or “if action X occurs during action Y”.

With reference to the example of FIGS. 6 and 7, in the particular clinical domain shown, such conditions 22d might correspond to statements like “if the drug Tamoxifen is taken during pregnancy”, or “if mastectomy surgery is undertaken in a patient over 65 years of age”.

The arguments in the argument/conflicts definition data structure are used to construct a case for or against the decision to take a particular action, and can hence be used to provide knowledge-based decision support during planning. The qualifier 22c of an argument indicates its force, for example, if this is an argument for or against the action, and how strong the argument is on a numeric or other scale. The logical arguments for and against each individual action proposed in the plan are generated according to a set of rules and appropriate mathematical reasoning system. On the basis of such logical arguments, rules may recommend actions when particular configurations of steps occur in a plan. A mathematical reasoning system of an appropriate type is discussed in J. Fox & S Das (2000), “Safe and Sound: Artificial intelligence in safety critical applications”, MIT Press.

Conflict specifications define interactions between events or actions which should be highlighted in the interactive planning display, eg. the GUI windows 60a, 70a. The qualifier field 22c is used to specify the nature of the highlighting (eg. a specific colour used to highlight graphical elements in the planning display). The conflict specification may specify that certain actions are mutually exclusive, that certain combinations of actions are impossible or have important consequences which the user should be notified of, or that certain actions have different consequences depending upon prior, subsequent or simultaneous actions.

The third type of data structure in the domain knowledge database 2 comprises a linked list of instance data item definition records 23 that specify the type of data that can be held for a particular instance on which the planning tool is used in a specific domain. For example, in a clinical domain, such data might include the name, age, sex and medical history of a patient for whom a care plan is to bc constructed.

The data structure comprises a series of records 23 that each include: a name field 23a that uniquely identifies the instance data item; a storage type flag 23b indicating whether the record is a string, integer, real number, boolean expression etc; an allowable value range indicator 23c; a source field 23d of the data structure specifying the source for this particular data item; and a pointer 23e to the next instance data object definition record. The source field may be a link to a pre-existing database (such as an electronic patient record database in a medical domain) or may be provided by the user in response to a request automatically generated by the software.

The data items defined in this data structure may be referred to in the conditions of argument or conflict definitions for the same domain.

The fourth type of data structure in the domain knowledge database 2 stores outcome measures that are specific to the domain under consideration. Each possible outcome measure is stored as a record 24 in a linked list of records. Each record 24 includes a distinct name or label field 24a; a storage type flag 24b; and an indicator 24c of the legal range of values. A formula field 24d provides a specification for calculating the value of the quantitative outcome measure at any given point in time in terms of the data currently held in instance data objects in session data 4 (as defined by the instance data definitions 23) and combinations of action or event instances occuring in the plan data object 5 prior to or at the time specified. Standard logical and arithmetic operators may be used in such formulae, as well as temporal expressions (before, after, during etc).

Referring back to FIG. 1, an authoring tool 6 provides a user interface to allow domain knowledge in the domain knowledge database 2 to be updated and new domains of application to be specified. It will be understood that the function of maintaining the domain knowledge database 2 using a domain knowledge authoring tool 6 may be performed separately from the planning operations and the planning tool may be provided with a series of pre-prepared domain knowledge databases that are populated and maintained by expert users. Thus the domain authoring tool need not form an integral part of the planning tool 1.

The current state of the plan that is composed or modified within the planning tool 1 is maintained in the plan data object 5. Optionally a number of separate plans may be maintained within this data object and worked on in turn by the user, enabling alternative strategies to be compared. The structure of a single plan in the plan data object is shown in FIG. 3.

The plan data object 5 comprises a series of linked records 31-1, 31-2, 31-3 each representing an action/event type definition that is or may be used within the plan. The action/event type definitions for the domain of use provide an index to the types of events or actions allowed within that domain, as specified by the domain knowledge database 2 action/event type definitions 21 (FIG. 2). It will be noted that each record 31-1, 31-2, 31-3 includes fields 31a, 31b, 31c, 31d, 31e that correspond with the definitions provided from the corresponding action/event type record fields 21a, 21b, 21c, 21d and 21e.

Each record 31-1, 31-2, 31-3 is augmented with a pointer 31f to a linked list of records for planned instance data objects 32, 33 and 34. Each instance data object record 32, 33, 34 represents a particular instance or occurrence of an event type or an action in the plan in question. With reference to planned instance record 32, each record preferably comprises fields indicating the earliest start time 32a, latest start time 32b, earliest end time 32c and latest end time 32d of the instance, thus allowing a degree of uncertainty by separating earliest and latest permissible times. Alternatively, only single start and end times might be recorded. The instance record 32 may also include a pointer field 32e to subsequent records.

Events and actions of “instantaneous” type are represented in these records 32 as having no duration, and use only the start time fields 32a and/or 32b.

Where multiple instances of the same action/event type 31 occur, there will be plural records in the linked list of instances, as shown with planned instances 33a, 33b, 33c Each record 33 pointer field 33e provides an address to the next instance record 33 in the chain, eg. record 33b, 33c.

Instance data is information that relates specifically to a particular instance in which the tool is used, for example a particular patient for whom a medical care plan is created. Instance data generally comprises the instance data item definitions of records 23 (FIG. 2) each augmented with a field specifying the actual value taken by the data item in the current instance.

The planning tool 1 generates two types of decision support feedback information as the user constructs and manipulates plans, by applying the argument/conflict definitions 22 and the outcome measure definitions 24 in the domain knowledge database 2 to the instance data 32, 33, 34 specified in the session data items 4 and the plan data object 5.

The interpretation and manipulation of the data retrieved from the records in the databases 2 and 3 according to the current state of the plan, to generate the desired outcome measures is carried out by a decision support engine 9 coupled to outcome measure visualisation tools 8.

The decision support engine 9 preferably operates continually so that feedback is always available to the user during manipulation of a plan, ie. in “real time”. It will be understood that the expression “real time” is intended to encompass small processing delays which might occur, for example immediately after placing, or moving, an element on the graphical user interface display 60a, 70a before the corresponding outcome measure 65, 75 is computed by decision support engine 9 and displayed in the outcome measure windows 60b, 70b of the output display 60, 70.

The two types of decision support information that can be provided by the planning tool 1 are quantitative outcome measures and qualitative outcome measures which may be referred to as symbolic decision support.

Each quantitative outcome measure 65, 75 comprises a set of numerical values, one for each of a set of time points covering the duration of the plan under construction (for example, one per year of a long-term plan as shown in FIGS. 6 and 7). For each time point, a value for the quantitative outcome measure is calculated using the function defined in the corresponding entry 24d in the domain knowledge base 2, which may include references to events and actions occurring before or at the specified time in the plan data object, and to current values of instance data items 32, 33, 34.

A simple example of such a function for the medical domain of prophylactic treatment for women at risk of breast cancer (as in FIGS. 6 and 7) might be:
IF (instance data indicates that the current patient is at genetic risk of breast cancer) AND (plan data indicates that drug treatment with Tamoxifen is planned to be in force at time t) THEN (Outcome measure “risk of contracting breast cancer” for time t is reduced by 20%).

The current state of the plan, in the context of the current instance data, thus determines the value of each quantitative outcome measure at each time point for the duration of the plan. In the planning tool 1, each quantitative outcome measure 65, 75 may be displayed as a graph of value against time on the planning user interface 60, 70.

Qualitative outcome measures, or symbolic decision support outputs are generated using the argument/conflict definitions 22 in the domain knowledge base 2. Each such definition 22 includes a set of conditions 22d which must match with the current state of the plan in the plan data object 5 and with the current values of instance data items 32, 33, 34 for that argument/conflict definition to become active. An active argument is used to provide recommendations and warnings to the user about configurations of events and actions in the plan in the context of the current instance data in instance database 3.

For example, a warning that a particular drug should not be used in a patient with a particular medical condition might be triggered by an argument against the use of the drug, which would be activated by a planned instance of drug use and an instance data item specifying the medical condition. All possible arguments for or against a particular action may also be reviewed for any action in the user planning interface.

Conflict specifications may be handled similarly to arguments, but are used to specify conditions under which particular planned actions or events should be highlighted in the user interface planning display to represent a conflict between elements in the plan. The decision support system determines, for each argument/conflict specification in the domain knowledge base, whether that argument/conflict definition should become active given the current state of the plan data object and instance data.

With further reference to FIG. 1, the user interface to the planning tool 1 has two principal components:

1. A plan visualisation, creation and manipulation interface 7 presents the graphical representation of the current state of the plan (eg. as in GUI windows 60a, 70a of FIGS. 6 and 7), in which actions and events are represented graphically as blocks or lines arranged against a horizontal time-line. The interface allows the user to create new actions or events, delete existing ones, or move the start and end points of existing actions and events to different points on the time line.

2. A set of visualisation tools 8 provide a visual presentation of the output of the planning tool consequent on the current state of the plan. Several such tools may be included:

a) Numerical or quantitative outcome measures (such as risk of developing a particular condition) are presented as graphs 65, 75 plotting the level of the outcome measure against time on the scale provided by the planning interface time line.

b) Planning constraints are visualised by highlighting portions of action and event representations on the planning interface display which activate conflict definitions. In the example of FIG. 7, it will be seen that a portion 76b of the “pregnancy” event 73a is coloured differently (eg. red) to the remainder portion 76a, which coloured portion 76b is concurrent with a corresponding coloured portion 77a of the planned action 72b, Tamoxifen treatment. This immediately highlights the advice that such a treatment plan is incompatible with pregnancy.

c) Qualitative outcome measures such as arguments for and against current plan configurations or elements may be reviewed. An example of an argument output is given in FIG. 5, where the output display 50 includes not only a first window 50a showing the current plan against timeline 51, and second window 50b showing quantitative outcome measures 55 in graphical form, but also a third window 50c displaying arguments for and against the proposed event or action (in the illustrated case, reducing blood pressure by predetermined lifestyle changes). In the preferred embodiment, the user displays these arguments by clicking the mouse on a particular plan element in the display.

d) Recommendations and warnings may be displayed in a separate window. In the example illustrated in FIG. 5, this may be effected by clicking on the button marked “Recommendations”.

In the preferred embodiment, all display windows are updated continually so as to show any changes in the output of the planning tool as soon as they occur during manipulation of the plan by the user.

The planning tool preferably also allows alternative plans to be compared to evaluate the impact of modifications. Plans are evaluated in terms of the predicted effect on outcome measures and the recommendations and warnings generated by the planning tool. Modified plans may be compared with each other and with the original plan on these measures.

With further reference to FIG. 1, the planning tool is preferably also provided with an import/export system 10 which allows plans 5 to be exported from the system in a machine-readable format, and allows pre-existing plans to be imported. For example, the plan specification language PROforma (“Safe and Sound: Artificial intelligence in safety-critical applications”, J Fox and S Das, 2000, MIT Press) allows standard medical care plans to be created in machine-readable form. Such care plans may be interpreted by a suitable software system to provide decision support or prompting to a clinician treating a patient, or can allow some or all actions in a plan to be carried out automatically. A standard care plan for a particular disease, written in PROforma, may be imported into the planning tool 1 by creating action instances in the plan data object corresponding to actions specified in the PROforma plan. The planning tool 1 then allows the consequences of the standard plan to be evaluated in the context of the instance data for the specific patient in question. The effect of altering the plan (for example, substituting alternative procedures, altering the timing of procedures or the order in which they are carried out) can be evaluated and compared with the original plan. Finally a modified plan may be exported in PROforma format by generating PROforma language structures corresponding to the action instances specified in the plan data object 5. This modified plan may then be used in place of the standard plan in clinical decision support or automation software.

Illustrations of use of the planning tool 1 will now be described.

FIG. 4 shows the main input/output screen 40 of the planning tool 1, as provided by the input/output modules 7, 8. In the figure, the planning tool 1 is configured for a medical domain of cardiovascular disease risk, as indicated by the option box 47 displayed at the top of the screen. A suitable domain may be selected by the user from available options using this menu box. The user is investigating the consequence of various medical interventions to reduce the risk of cardiovascular disease.

Towards the top of FIG. 4 is the planning area 40a, with a time line 41 running from left to right (marked with the age of the patient in years) and a selection of possible interventions 42 listed at the left hand side. The user is able to draw regions on the planning chart within which interventions will be applied.

Beneath the planning area 40a is a quantitative outcome measures display window 40b showing a graph 45 of the risk of developing cardiovascular disease in any particular year, based on the current proposed plan. The horizontal scale of the graph is aligned with the time line 41 of the planning area so that changes in risk associated with planned interventions can be easily seen. The projected risk level is re-calculated for each year of the plan continually, so the effects of changing the plan are immediately evident to the user.

Towards the bottom of FIG. 4 is a window 40d displaying recommended actions. These messages are determined by the set of argument/conflict definition conditions 22d in domain knowledge database 2 records which are continually applied to the current state of the plan. They include recommendations, warnings about inappropriate actions and other useful information, and change to reflect the state of the plan as the user modifies it. These messages represent one form of knowledge-based decision support for planning in a specific application.

Another form of decision support is shown in FIG. 5, where arguments summarising the “pros and cons” of particular actions are displayed in window 50c. This information is displayed in response to the user selecting the start or end of an action 52a, 52b, or 52c on the planning area, and relate to the decision to start or end that action. In the example given, action 52b has been selected to enable display of arguments for and against the reduction of blood pressure through a predetermined specification of lifestyle changes.

A more complex medical domain is shown in FIGS. 6 and 7, which has already been discussed in part. Here the risk of death due to genetic predisposition to breast cancer is the quantitative outcome measure shown in the outcome measures window 60b, and interventions or events 62 are aimed at mitigating that risk. FIG. 6 shows a plan being constructed with both anticipated events 63 (pregnancy and breast-feeding) and planned actions 62. FIG. 7 shows the instantaneous change in the projected risk profile (outcome measure 75) as a new action (bilateral mastectomy) is planned, and shows the highlighting of a conflict between tamoxifen drug treatment and pregnancy.

FIG. 8 shows an example of a different type of medical domain—the planning of care for a patient who is currently ill, rather than planning to reduce risk of becoming ill. Here treatment is being planned, as shown in the planning window 80a, for limited breast cancer. The quantitative outcome measure displayed in window 80b is the risk of death due to the condition, which reduces as treatment progresses. Recommendations for treatment options specific to the current patient's condition are also displayed in a recommendations window 80d. The effect on risk of following these recommendations may easily be compared with the effect of alternative treatment options.

It will be clear that for both expert and non-expert users, the presentation of plans together with outcome measures derived from a domain-specific knowledge database, can significantly reduce the risk of errors of judgement in determining an appropriate treatment or care plan for a specific patient, by flagging high risk situations in a plan, or by enabling the user to see relative comparison of risks associated with different plans or reductions in risks by making modifications in plans.

While medical care domains have been specifically described, the invention is equally applicable to planning in other domains. Some examples are:

a) The construction industry. Appropriate domains include planning of stages of construction, deployment of resources and procurement of materials. Outcome measures could include cost, resources required, time required to reach targets, and risk of failure to reach targets.

b) The financial services industry. Applications include comparison of the performance and risks of different investment products over time, including the impact of planned and unplanned events. For example, a house buyer might compare the effect of different patterns of housing market development and long-term moving plans on the performance of alternative mortgage products.

c) Business planning. Applications include comparing the effect on anticipated profit of possible market events, actions of competitors, and alternative business strategies.

1. A planning apparatus comprising:
means for displaying a visual representation of a plurality of schedule elements along a time line;
means for enabling manipulation, by a user, of relative positions and extents of the plurality of schedule elements along the time line to form a plan;
a database of relationship data including interdependencies and planning constraints between specified ones of the schedule elements;
a domain-specific knowledge database of outcome measures providing quantitative or qualitative measures of outcomes consequent on specific schedule elements or specific combinations, sequential or otherwise, of schedule elements on the plan according to a predetermined domain of use of the planning apparatus;
means for displaying, during or after manipulation of events by the user, selected outcome measures resulting from the specific sequence of schedule elements currently displayed.

2. Apparatus according to claim 1 in which the schedule elements comprise any of planned actions, past actions, anticipated events, past events, events or actions instantaneous in time, and events or actions extended in time.

3. Apparatus according to claim 1 in which the means for manipulating comprises means for “clicking and dragging” displayed events on a computer screen.

4. Apparatus according to claim 1 in which the database of relationship data including interdependencies and planning constraints between specified ones of the scheduled events includes rules specifying any of the following: mutual exclusivity of specified event combinations, forced sequentiality of specified event combinations; commutativity or non-commutativity of specified events; consequences of events dependent upon prior, subsequent or simultaneous events.

5. Apparatus according to claim 1 in which the database of outcome measures providing quantitative or qualitative measures of outcomes consequent on specific scheduled events or specific combinations of events includes any of the following: predicted or predetermined measures of risk, cost or benefits, measures of desirability of a plan or plan element, potential conflict within the plan and logical arguments for and/or against a current plan configuration.

6. Apparatus according to claim 1 or claim 5 further including means for selecting for display one or more of said outcome measures from a selection of possible outcome measures.

7. Apparatus according to claim 6 further including a plurality of domain-specific knowledge databases, said means for selecting including means for enabling access to different ones of the plurality of domain-specific knowledge databases.

8. Apparatus according to claim 1 further including means for displaying logical arguments for and against each event or combination of events in the displayed visual representation of the plan.

9. Apparatus according to claim 8 further including means for indicating a quantitative measure of the strength of said logical arguments.

10. Apparatus according to claim 1 further including means for displaying recommended actions arising in respect of each event or combination of events in the displayed visual representation of the plan.

11. Apparatus according to claim 1 further including means to display said selected outcome measures graphically.

12. Apparatus according to claim 1 further including means to display said selected outcome measures graphically and coincident with the time line of the scheduled events.

13. Apparatus according to claim 4 further including means for applying information from the database of relationship data to display interactions between said events or violations of interdependencies or planning constraints.

14. Apparatus according to claim 5 in which the database of outcome measures provides said quantitative or qualitative measures of outcomes consequent on specific scheduled events or specific combinations of events as dynamic information, the database further comprising static instance measures data applicable to the plan as a whole.

15. Apparatus according to claim 1 in which the scheduled events relate to medical interventions applied to a patient.

16. Apparatus according to claim 12 in which the outcome measures include quantitative measures of risk of development of certain medical conditions by a patient.

17. A planning apparatus comprising:
means for displaying a visual representation of a plurality of schedule elements along a time line;
means for enabling manipulation, by a user, of relative positions and extents of the schedule elements along the time line to form a plan;
an instance database storing data defining the schedule elements of the current plan and session data specific to that plan;
means for enabling selection, by a user, of a domain in which the plan is effected, the selected domain determining the schedule elements available to form the plan;
means for accessing a domain-specific knowledge database of predetermined outcome measures so as to provide quantitative or qualitative measures of outcomes consequent on the schedule elements selected in the current plan and the positioning thereof;
means for displaying, during or after manipulation of events by the user, selected outcome measures resulting from the current configuration of schedule elements in the plan.

18. The apparatus of claim 17 in which the outcome measures displayed include quantitative measures of predicted risk levels associated with the plan or plan elements or measures of desirability of the current plan or plan elements.

19. The apparatus of claim 17 in which the outcome measures displayed include qualitative measures comprising logical arguments for or against the current plan configuration.

20. The apparatus of claim 17 in which the outcome measures displayed include qualitative measures comprising recommended actions arising from the current plan configuration.

21. A method for automatically determining a level of desirability of a plan comprising a plurality of schedule elements along a time line, the method comprising the steps of:
displaying, on a computer apparatus, a visual representation of said plurality of schedule elements along the time line;
enabling manipulation, by a user, of relative positions and extents of the schedule elements along the time line to form said plan;
accessing a database of relationship data including interdependencies and planning constraints between specified ones of the schedule elements to automatically indicate, on the computer display, conflicts between plan elements;
accessing a domain-specific knowledge database of outcome measures providing quantitative or qualitative measures of outcomes consequent on specific schedule elements or specific combinations, sequential or otherwise, of schedule elements on the plan according to a predetermined domain of use of the planning apparatus to automatically determine selected outcome measures resulting from the current plan configuration being displayed; and
displaying, during or after manipulation of events by the user, said selected outcome measures.

22. A method for automatically determining a level of desirability of a plan comprising a plurality of schedule elements along a time line, the method comprising the steps of:
displaying, on a computer apparatus, a visual representation of said plurality of schedule elements along the time line;
enabling manipulation, by a user, of relative positions and extents of the schedule elements along the time line to form a plan;
storing, in an instance database, data defining the schedule elements of the current plan and session data specific to that plan;
enabling selection, by a user, of a domain in which the plan is effected, the selected domain automatically determining the schedule elements available for use to form the plan;
accessing a domain-specific knowledge database of predetermined outcome measures so as to automatically provide quantitative or qualitative measures of outcomes consequent on the schedule elements selected in the current plan and the positioning thereof, and
displaying, during or after manipulation of events by the user, selected said outcome measures resulting from the current configuration of schedule elements in the plan.

23. A computer program product, comprising a computer readable medium having thereon computer program code means adapted, when said program is loaded onto a computer, to make the computer execute the procedure of either one of claims 21 and 22.
